(19) United States
(12) Patent Application Publication
(10) Pub. No.: US 2019/0091584 A1
(43) Pub. Date: Mar. 28, 2019

(54) METHOD AND SYSTEM FOR PROVIDING SPORT GAME SERVICE BY REFLECTING REAL GAME RESULT

(71) Applicants: NHN Entertainment Corporation, Seongnam-si (KR); NHN Bigfoot Corporation, Seongnam-si (KR)

(72) Inventor: Yeong Seung JIN, Seongnam-si (KR)

(21) Appl. No.: 16/137,548

(22) Filed: Sep. 21, 2018

(30) Foreign Application Priority Data
Sep. 25, 2017 (KR) 10-2017-0123687

(51) Int. Cl. A63F 13/828; A63F 13/79

(52) U.S. Cl. CPC A63F 13/828; A63F 13/79

(57) ABSTRACT

A method of providing a sports game service by automatically reflecting a real sports match result includes receiving a login request signal from a user terminal of a user, receiving real sports match data from a database, automatically updating game information of the user based on the real sports match data, confirming the game information of the user corresponding to a login request, and progressing a game using the game information of the user.

### CROSS REFERENCE TO RELATED APPLICATION

This application claims priority from and the benefit of Korean Patent Application No. 10-2017-0123687, filed on Sep. 25, 2017, which is hereby incorporated by reference for all purposes as if fully set forth herein.

### BACKGROUND

### Field

Exemplary embodiments of the invention relate generally to a method and a system for providing a sports game service by automatically reflecting a real sports match result.

### Discussion of the Background

In general, the Internet is an open network which is configured to enable anybody to freely access and use the other party computer anywhere in the world, and makes it possible for users to use various services, such as e-mail and file transmission. For example, the Internet is used to transmit multimedia information as well as basic text information, with the development of a compression technique.

Examples of the businesses using the Internet include sites providing a variety of content, such as an Internet advertisement site, an Internet broadcast site, an online game site, an Internet newspaper/magazine site, a search service site, a portal service site, and an e-commerce site, and their use is rapidly increasing.

Recently, online game service providers, which provide various game services in order for users to spend free time or spare time, have greatly increased. Many users have used various kinds of games by accessing online game sites or dedicated applications. Among these are sports games such as a soccer game and a baseball game which are provided by such online game service providers.

However, in such sports games, since information on players constituting a corresponding sports game is updated for each version and an update interval is long, there is a gap between a sports game and a real sports match such as a gap between ability of a player in the sports game and ability of a player in the real sports match. Thus, a user may have decreased expectation and interest with respect to the sports game.

The above information disclosed in this Background section is only for understanding of the background of the inventive concepts, and, therefore, it may contain information that does not constitute prior art.

### SUMMARY

Devices constructed and methods according to exemplary embodiments of the invention are capable of providing a sports game service by reflecting a real sports match result, in which a corresponding real sports match result is reflected in a sports game to improve the user's experience in playing the sports game in a condition similar to an environment of the real sports match.

Additional features of the inventive concepts will be set forth in the description which follows, and in part will be apparent from the description, or may be learned by practice of the inventive concepts.

According to one or more embodiments of the invention, a method of providing a sports game service by automatically reflecting a real sports match result includes: receiving a login request signal from a user terminal of a user; receiving real sports match data from a database; automatically updating game information of the user based on the real sports match data; confirming the game information of the user corresponding to a login request; and progressing a game using the game information of the user.

The game information may include at least one of player information constituting a team, lineup information, training information, league information, and match information.

The player information may include physical strength of the players, a condition of the players, an injury status of the players, a salary of the players, and a transfer fee of the players.

The receiving of the real sports match data from the database may include receiving the real sports match data from the database at a set time interval.

The receiving of the real sports match data from the database at the set interval may include receiving the real sports match data from the database at one week interval.

The receiving of the real sports match data from the database may include receiving the real sports match data from the database in real time.

The automatically updating of the game information of the user based on the real sports match data may include updating the game information of the user based on the real sports match data at a set time interval.

The updating of the game information of the user based on the real sports match data at the set time interval may include updating the game information of the user based on the real sports match data at one week interval.

The automatically updating of the game information of the user based on the real sports match data may include updating the game information of the user based on the real sports match data in real time.

The receiving of the real sports match data from the database may include receiving data on at least one of a game play time of players, a game record of the players, an injury of the players, an outcome of a real sports match of the players' teams, and a mileage of the players (which may refer to distance ran by the players).

The automatically updating of the game information of the user based on the real sports match data may include changing ability of players constituting a team of the user based on the real sports match data.

The automatically updating of the game information of the user based on the real sports match data may include changing a salary and a transfer fee of players constituting a team of the user based on the real sports match data.

The progressing of the game by using the game information of the user may include stopping the game from being progressed when a total amount of changed salaries of the players constituting the team of the user exceeds a salary gap.

According to one or more embodiments of the invention, a method of providing a sports game service by reflecting a real sports match result includes: receiving a login request signal from a user terminal of a user; confirming game information of the user corresponding to a login request and progressing a game by using the game information of the user; receiving real sports match data from a database; automatically updating the game information of the user based on the real sports match data; and progressing the game using the updated game information of the user.

The receiving of the real sports match data from the database may include receiving the real sports match data from the database at a time set interval.

The receiving of the real sports match data from the database at the set interval may include receiving the real sports match data from the database at one week interval.

The receiving of the real sports match data from the database may include receiving the real sports match data from the database in real time.

According to one or more embodiments of the invention, a system for providing a sports game service by reflecting a real sports match result includes: a game server configured to receive a login request signal from a user terminal of a user, receive real sports match data from a database to automatically update game information of the user based on the real sports match data, and progress a game using the game information of the use corresponding to a login request.

The system may further include a database configured to store data on at least one of a game play time of players, a game record of the players, an injury of the players, an outcome of a real sports match of the players' teams, and a mileage of the players (which may refer to distance ran by the players).

The game information may include at least one of player information constituting a team, lineup information, training information, league information, and match information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a diagram illustrating a relationship between a user terminal, a network, a game server, and a database according to an exemplary embodiment.

FIGS. 2 and 3 are flowcharts of methods of providing a sports game service by reflecting a real sports match result according to an exemplary embodiment.

FIGS. 4A, 4B, and 4C are tables showing a process of updating game information of a user based on real sports match data according to an exemplary embodiment.

FIGS. 5A, 5B, and 5C are exemplary tables showing a process of updating game information of a user using point-based calculations based on real sports match data according to an exemplary embodiment.

FIG. 6 is an exemplary conversion table showing a process of updating the game information of the user based on the points calculated from the real sports match data according to the exemplary embodiment of FIGS. 5A, 5B, and 5C.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, regions, and/or aspects, etc. (hereinafter individually or collectively referred to as “elements”), of the various embodiments may be otherwise combined, separated, interchanged, and/or rearranged without departing from the inventive concepts.

Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of s the relevant art and should not be interpreted in an idealized or overly formal sense, unless expressly so defined herein.

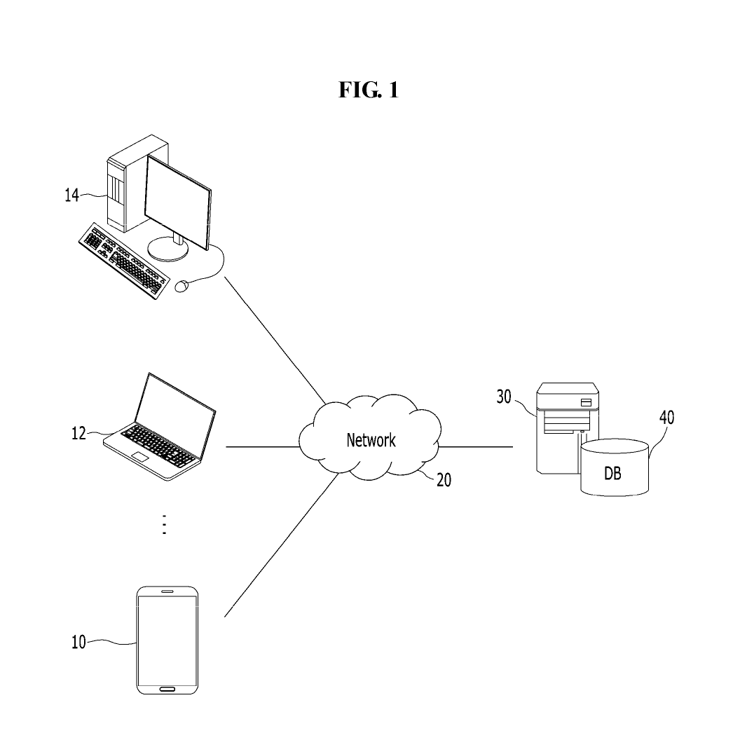

FIG. 1 is a diagram illustrating a relationship between a user terminal, a network, a game server, and a database according to an exemplary embodiment.

Referring to FIG. 1, a system for providing a sports game service by reflecting a real sports match result includes a game server 30 and is connected to user terminals 10, 12, and 14, and a database 40 through a network 20 to transmit and receive all data and information necessary for a sports game.

When a user starts a sports game by executing a game module installed in the user terminals 10, 12, and 14, the user terminals 10, 12, and 14 request the game server 30 for user authentication (login) through the network 20. When the game is started, the user terminals 10, 12, and 14 transmit and receive all data and information necessary for progressing the game to and from the game server 30 and displays the transmitted and received all data and information to the user.

FIG. 1 illustrates that a mobile communication terminal 10, a laptop computer 12, and a desktop computer 14 connected to the network 20 to transmit and receive data as typical examples of the user terminals 10, 12, and 14, but a terminal is not limited to the mobile communication terminal. The terminal may include various terminals, such as all information and communication devices, multimedia terminals, wired/wireless terminals, fixed terminals, and internet protocol (IP) terminals. In addition, the terminal may include mobile terminals having various mobile communication specifications, such as a mobile phone, a portable multimedia player (PMP), a mobile internet device (MID), a smartphone, a desktop PC, a tablet PC, a laptop computer, a netbook, a server, and an information and communication device.

As the network 20, various types of communication networks may be used, and for example, wireless communication methods such as wireless LAN (WLAN), Wi-Fi, Wibro, Wimax, high speed downlink packet access (HSDPA), etc., may be used, or wired communication methods such as Ethernet, xDSL (ADSL or VDSL), hybrid fiber coax (HFC), fiber to the curb (FTTC), fiber to the home (FTTH), etc., may be used. Meanwhile, the network 20 is not limited to the above-mentioned communication methods, and may include all types of communication methods which are well-known or will be developed in the future in addition to the above-mentioned communication methods.

The game server 30 provides a game service by transmitting and receiving all data necessary for progressing a sports game to and from the user terminals 10, 12, and 14 through the network 20.

In an exemplary embodiment, the game server 30 performs a user login process by receiving a user authentication request for a game start from the user terminals 10, 12, and 14. In an example, the game server 30 may provide a launching module necessary for executing a game.

The game server 30 receives real sports match data from the database 40 and updates sports game information of the corresponding sports game based on the real sports match data. In an example, the sports game may include at least one of baseball, soccer, basketball, football, and golf. The sports game information may include at least one of player information constituting a team, lineup information, training information, league information, and match information. The player information may include physical strength of the players, a condition of the players, an injury status of the players, a salary of the players, and a transfer fee of the players. In addition, the data on the real sports match may include at least one of a game play time of the players, a game record of the players, an injury of the players, outcome of the real sports match of the players' teams, and a mileage of the players (which may refer to distance run by the players).

In an exemplary embodiment of the present invention, the game server 30 receives real sports match data from the database 40 in real time and updates game information. In an exemplary embodiment, the game server 30 may receive the real sports match data from the database 40 at a set time interval and may update game information. The set time interval may be, for example, a one week interval or every time at which a sports game is ended, but the present disclosure is not limited thereto. The set time interval may mean various time intervals as needed.

The game server 30 receives real sports match data from the database 40 in real time and updates game information in real time. In an exemplary embodiment, the game server 30 may receive real sports match data from the database 40 and may update game information at a set time interval. Likewise, the set time interval may mean one week interval or every time at which a corresponding real sports match is ended, but the present disclosure is not limited thereto. The set time interval may mean various time intervals as needed

The game server 30 may include a server operated by a sports game service provider. For example, the game server 30 may include a server operated by game providers such as Nexon, Hangame, EA Games, Blizzard, and NCsoft. In an exemplary embodiment, the system for providing the sports game service by reflecting the real sports match result according to the present disclosure may further include a web server providing a launching module which is configured to perform a login process of a user and is necessary for executing a game. In an exemplary embodiment, the game server 30 may include a web server and may provide a launching module which is configured to perform a login process of a user and execute a game.

The database 40 stores all information necessary for progressing a game, which includes information for user authentication. In an exemplary embodiment, the database 40 may store information including at least one of a game play time of players, a game record of the players, an injury of the players, outcome of the real sports match of the players' teams, and a mileage of the players (which refers to distance run by the players) in a real sports match for reflecting a real sports match result in a sports game.

As described above, in the system for providing the sports game service by reflecting the real sports match result according to the present disclosure, the game server 30 may receive a real sports match result from the database 40 and may update game information based on the received real sports match result, so that a user may enjoy a game in a condition similar to a real environment and have fun running a team including players who are close to reality, while playing the game.

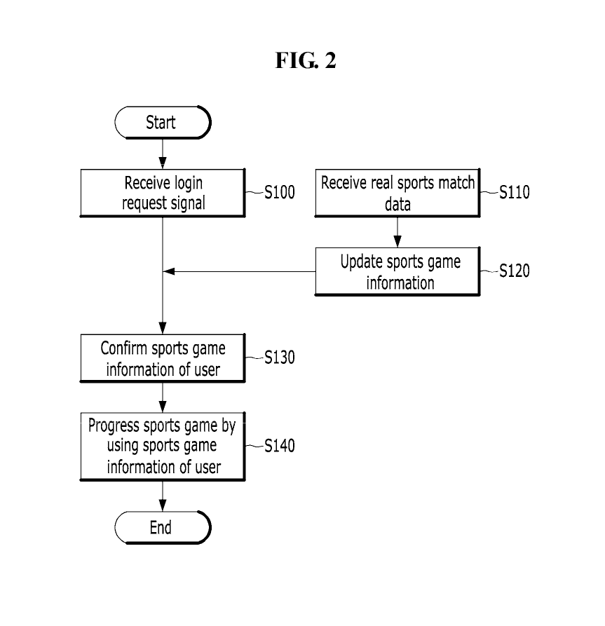

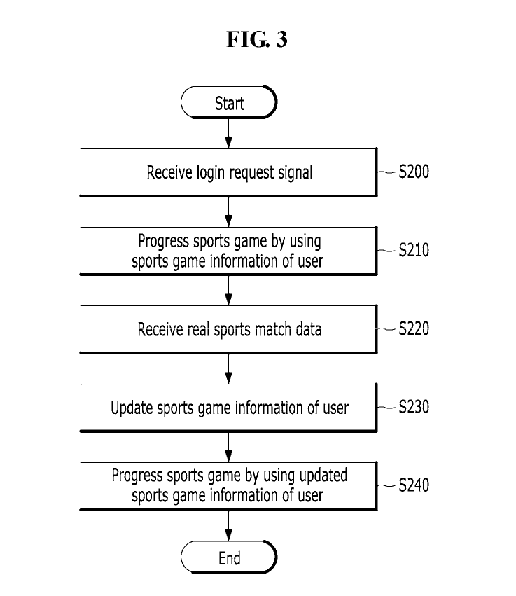

FIGS. 2 and 3 are flowcharts of methods of providing a sports game service by reflecting a real sports match result according to an exemplary embodiment.

Referring to FIG. 2, in order for the method of providing the sports game service by reflecting the real sports match result according to the exemplary embodiment, a game module installed in a user terminal is executed by a user.

A game server receives real sports match data from a database (S110), and updates game information based on the real sports match data (S120). In an exemplary embodiment, the game server may receive real sports match data from the database in real time and may update game information. In an exemplary embodiment, the game server may receive real sports match data from the database at a set time interval and may update game information. The set time interval may mean one-week interval or every time at which a corresponding sports game is ended, but the present disclosure is not limited thereto. The set time interval may mean various time intervals as needed. For example, the game server may receive real sports match data from the database at 00:00 hour every Tuesday and may update game information. In an exemplary embodiment, the game server receives real sports match data from the database and may update game information in real time. In an exemplary embodiment, the game server may receive real sports match data from the database and may update game information at a set time interval. Likewise, the set time interval may mean one-week interval or every time at which a corresponding sports game is ended, but the present disclosure is not limited thereto. The set time interval may mean various time intervals as needed. For example, the game server may receive real sports match data from the database and may update game information at 00:00 hour every Tuesday.

In an exemplary embodiment, the game server may change at least one of ability, a salary, and a transfer fee of players constituting a team of a user, based on real sports match data.

When a login request signal for starting a game is received from the user terminal (S100), the game server confirms game information of a user corresponding to a login request (S130). In an exemplary embodiment, the game information may include at least one of information on players constituting a team, lineup information, training information, league information, and game information. The information on the players may include physical strength of the players, a condition of the players, an injury status of the players, a salary of the players, and a transfer fee of the players. In addition, data on a real sports match may include at least one of a game play time of players, a game record of the players, an injury of the players, outcome of the real sports match of the players' teams, and a mileage of the players (which refers to distance ran by the players).

The game server progresses a game by using the game information of the user (S140). In an exemplary embodiment, the game server may progress a game by using players of which ability, a salary, and a transfer fee are changed based on the real sports match data. In an exemplary embodiment, when a total amount of changed salaries of players constituting the team of the user exceeds a salary gap, the game server may stop the sports game of the user from being progressed. The user may progress the game by transferring some high-salaried players of the players such that the total amount of the salaries of the players constituting the team of the user does not exceed the salary gap, or raising the salary gap by purchasing items or the like.

Referring to FIG. 3, the method of providing the sports game service by reflecting the real sports match result according to the exemplary embodiment starts in response to a user executing a game module installed in a user terminal of the user.

When a login request signal for starting a game is received from a user terminal (S200), a game server confirms game information of a user corresponding to a login request and progresses the game by using the game information of the user (S210). The game server receives real sports match data from a database (S220), updates game information based on the real sports match data (S230), and progress the game by using the updated game information of the user (S240).

In an exemplary embodiment, the game server may receive real sports match data from the database in real time and may update game information. In an exemplary embodiment, the game server may receive real sports match data from the database at a set time interval and may update game information. The set time interval may mean one week interval or every time at which a corresponding sports game is ended, but the present disclosure is not limited thereto. The set time interval may mean various time intervals as needed. For example, the game server may receive real sports match data from the database at 00:00 hour every Tuesday and may update game information.

In an exemplary embodiment, the game server may change or update at least one of ability, a salary, and a transfer fee of players constituting a team of a user, based on real sports match data.

In an exemplary embodiment, the game information may include at least one of player information constituting a team, lineup information, training information, league information, and match information. The player information may include physical strength of the players, a condition of the players, an injury status of the players, a salary of the players, and a transfer fee of the players. In addition, data on a real sports match may include at least one of a game play time of players, a game record of the players, an injury of the players, outcome of the real sports match of the players' teams, and a mileage of the players (which refers to distance ran by the players).

In an exemplary embodiment, the game server may progress the game by using players of which ability, a salary, and a transfer fee are changed based on the real sports match data. In an exemplary embodiment, when a total amount of changed salaries of players constituting the team of the user exceeds a salary gap, the game server may stop the game of the user from being progressed. The user may progress the game by transferring some high-salaried players of the players such that the total amount of the salaries of the players constituting the team of the user does not exceed the salary gap, or raising the salary gap by purchasing items or the like.

In an exemplary embodiment, FIG. 3 illustrates a case in which while a user is playing a game, real sports match data is received and game information of the user is updated. A case in which a game server progresses a game by using updated game information of a user may be applied when the user starts a new match after ending one match inside a game.

Embodiments of the method of providing the sports game service by reflecting the real sports match result according to the present disclosure have been described based on the system for providing the sports game service by reflecting the real sports match result in FIG. 1. However, the method of providing the sports game service by reflecting the real sports match result according to the present disclosure is not limited thereto and may be performed by using other various systems for providing a sports game service.

As described above, in the method of providing the sports game service by reflecting the real sports match result according to the exemplary embodiment, a game server may receive a real sports match result from a database and may update game information based on the received real sports match result, so that a user may enjoy a game in a condition similar to a real environment and have fun running a team including players who are close to reality, while playing the game.

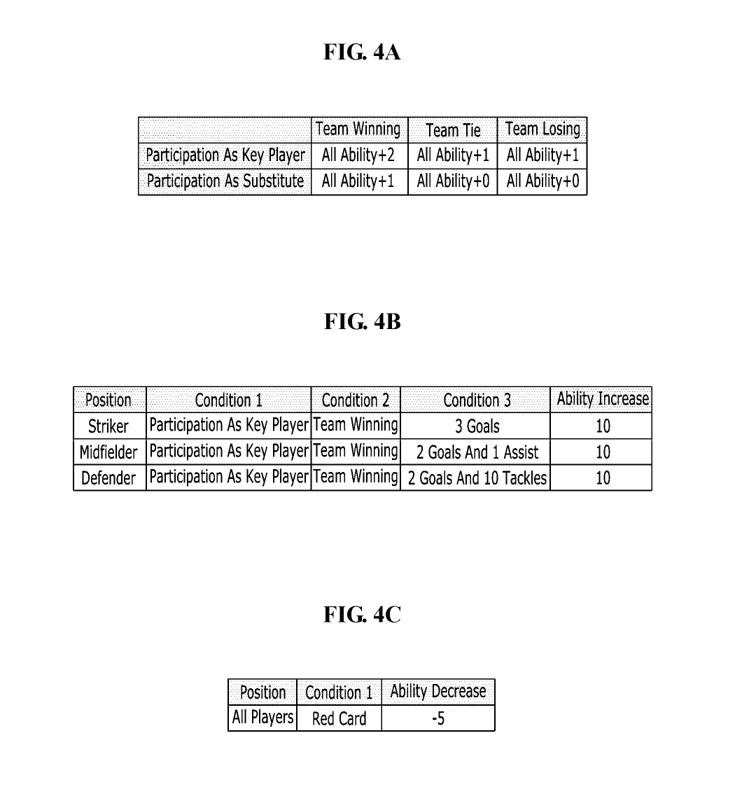

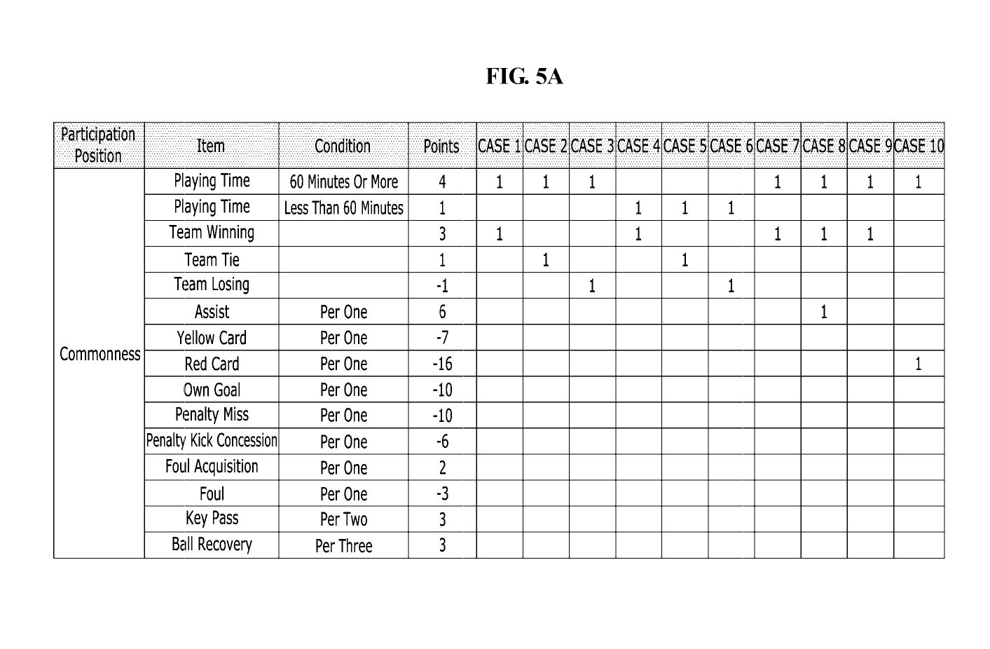

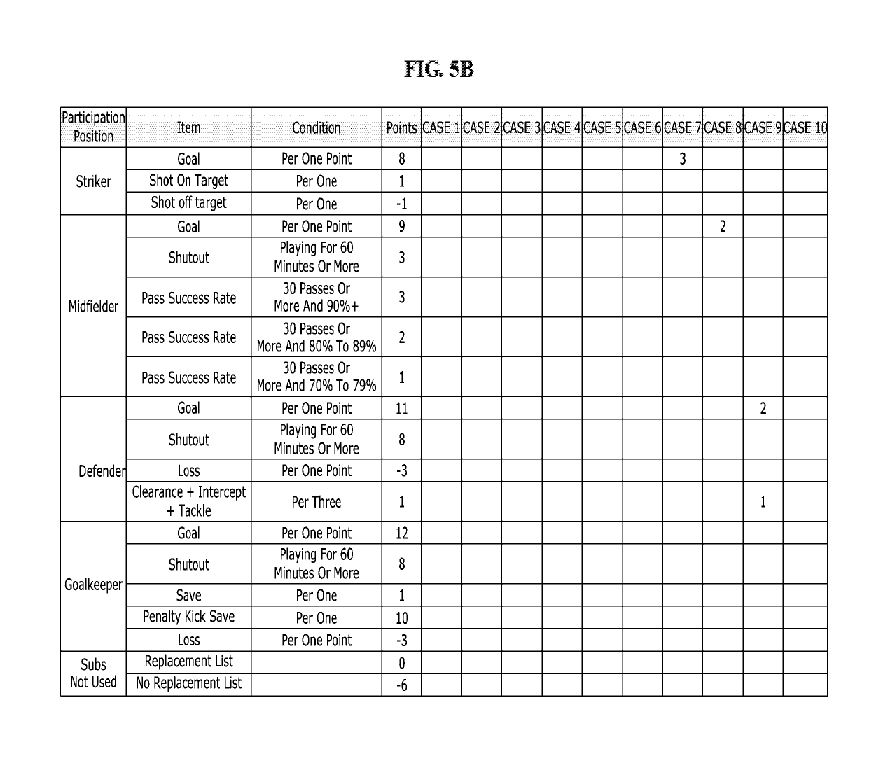

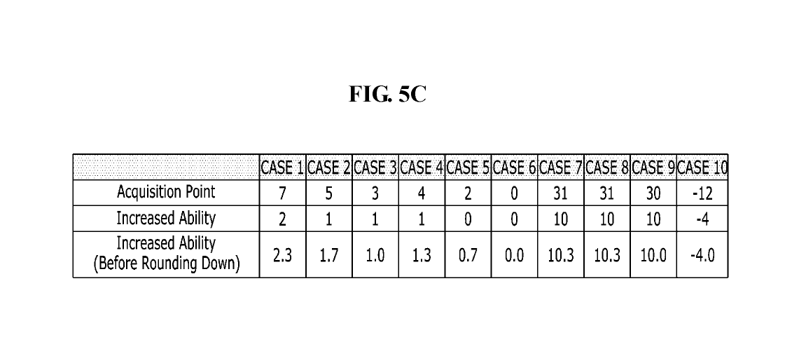

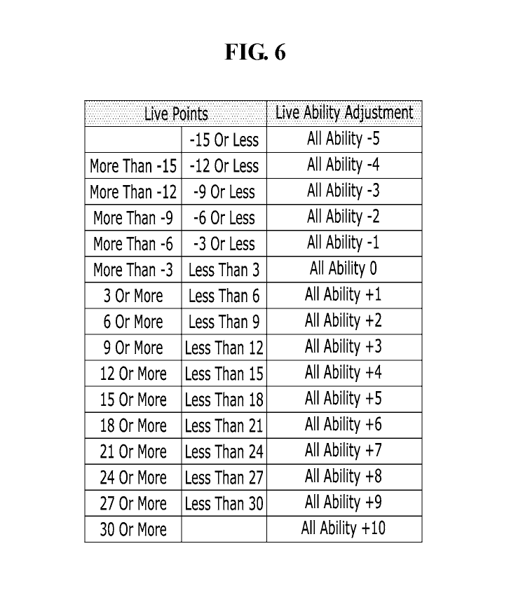

FIGS. 4A, 4B, and 4C are tables showing a process of automatically updating game information of a user based on real sports match data according to an exemplary embodiment. FIGS. 5A, 5B, and 5C are exemplary tables showing a process of automatically updating game information of a user using point-based calculations based on real sports match data according to an exemplary embodiment. FIG. 6 is an exemplary conversion table showing a process of automatically updating the game information of the user based on the points calculated from the real sports match data according to the exemplary embodiment of FIG. 5.

In FIGS. 4A, 4B, 4C, 5A, 5B, 5C, and 6, a sports game is illustrated as a soccer game. As described above, the sports game may include any kind of sports, including at least one of soccer, baseball, basketball, football, golf, and the like.

In the case of the soccer game, a user selects players constituting a team and progresses a game. The game may be progressed by including at least one of a league game, a cup tournament, a friendly game, and training. Ability of each of players is an important factor which determines winning or losing of the game.

In an exemplary embodiment, FIGS. 4A, 4B, and 4C show criteria for changing ability of players according to participation of players, winning or losing of a team, a position, and exiting in a real soccer match.

Referring to FIG. 4A, the criteria indicate that, when a player was in the starting lineup of the match that the team won, the player's ability is increased by 2, when a player was in the starting lineup of the match that the team tied or lost, the player's ability is increased by 1, when a player was a substitute player of the match that the team won, the player's ability is increased by 1, and when a player was a substitute player of the match that the team tied or lost, the player's ability remains the same.

Referring to FIG. 4B, several criteria indicate increasing ability by 10 according to a position played by the player.

Referring to FIG. 4C, when a player receives a red card and ejected from the game, the player's ability is decreased by 5.

In an exemplary embodiment, FIGS. 5A, 5B, and 5C show examples of point-based calculations for changing ability of players in a soccer game according to a game result of ten players in a real soccer match.

Referring to FIG. 5A, points are given to players based on criteria such as a playing time, outcome of the real sports match of the player's team, assist, a yellow card, a red card, an own goal, a penalty miss, a penalty kick concession, a foul acquisition, a foul, a key pass, and a ball recovery.

Referring to FIG. 5B, the illustrated criteria and examples include giving points to each player' ability according to the player's position, including a striker, a midfielder, a defender, and a goalkeeper.

Referring to FIG. 5C, the sum of the points calculated in FIGS. 5A and 5B and the player's ability may be increased, according to the calculated sum of the points, so as to be reflected in ability of a player inside the game.

In an exemplary embodiment, FIG. 6 shows a conversion table for converting LIVE points, which refers to the sum of the points calculated in FIGS. 5A and 5C, into LIVE ability adjustment to be reflected in ability of a player inside the game.

As described above, according to embodiments, in the method and the system for providing the sports game service by reflecting the real sports match result according to the exemplary embodiment, a game server may receive a real sports match result from a database and may update game information based on the received real sports match result, so that the sports game service may provide a game having a condition similar to a real environment, and the user may have immersive experience from playing the sports game with teams including players who are close to reality. In addition, when a real sports match result is reflected every predetermined period, it is possible to increase the tension in the sports game progress and increase the expectation and interest of the sports game by providing unexpectedness in which momentum of the sports game may be changed whenever the game information is updated.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method of providing a sports game service by automatically reflecting a real sports match result, the method comprising:
receiving a login request signal from a user terminal of a user;
receiving real sports match data from a database;
automatically updating a game information of the user based on the real sports match data;
confirming the game information of the user corresponding to a login request; and
progressing a game using the game information of the user.

2. The method of claim 1, wherein the game information comprises at least one of player information constituting a team, lineup information, training information, league information, and match information.

3. The method of claim 2, wherein the player information comprises physical strength of the players, a condition of the players, an injury status of the players, a salary of the players, and a transfer fee of the players.

4. The method of claim 1, wherein the receiving of the real sports match data from the database comprises receiving the real sports match data from the database at a set time interval.

5. The method of claim 4, wherein the receiving of the real sports match data from the database at the set interval comprises receiving the real sports match data from the database at one week interval.

6. The method of claim 1, wherein the receiving of the real sports match data from the database comprises receiving the real sports match data from the database in real time.

7. The method of claim 1, wherein the automatically updating of the game information of the user based on the real sports match data comprises updating the game information of the user based on the real sports match data at a set time interval.

8. The method of claim 7, wherein the updating of the game information of the user based on the real sports match data at the set time interval comprises updating the game information of the user based on the real sports match data at one week interval.

9. The method of claim 1, wherein the automatically updating of the game information of the user based on the real sports match data comprises updating the game information of the user based on the real sports match data in real time.

10. The method of claim 1, wherein the receiving of the real sports match data from the database comprises receiving data on at least one of a game play time of players, a game record of the players, an injury of the players, an outcome of a real sports match of the players' teams, and a mileage of the players.

11. The method of claim 1, wherein the automatically updating of the game information of the user based on the real sports match data comprises changing ability of players constituting a team of the user based on the real sports match data.

12. The method of claim 1, wherein the automatically updating of the game information of the user based on the real sports match data comprises changing a salary and a transfer fee of players constituting a team of the user based on the real sports match data.

13. The method of claim 12, wherein the progressing of the game by using the game information of the user comprises stopping the game from being progressed when a total amount of changed salaries of the players constituting the team of the user exceeds a salary gap.

14. A method of providing a sports game service by reflecting a real sports match result, the method comprising:
receiving a login request signal from a user terminal of a user;
confirming game information of the user corresponding to a login request and progressing a game by using the game information of the user;
receiving real sports match data from a database;
automatically updating the game information of the user based on the real sports match data; and
progressing the game using the updated game information of the user.

15. The method of claim 14, wherein the receiving of the real sports match data from the database comprises receiving the real sports match data from the database at a time set interval.

16. The method of claim 15, wherein the receiving of the real sports match data from the database at the set interval comprises receiving the real sports match data from the database at one week interval.

17. The method of claim 14, wherein the receiving of the real sports match data from the database comprises receiving the real sports match data from the database in real time.

18. A system for providing a sports game service by automatically reflecting a real sports match result, the system comprising:
a game server configured to receive a login request signal from a user terminal of a user, receive real sports match data from a database to automatically update a game information of the user based on the real sports match data, and progress a game using the game information of the use corresponding to a login request.

19. The system of claim 18, further comprising a database configured to store data on at least one of a game play time of players, a game record of the players, an injury of the players, an outcome of a real sports match of the players' teams, and a mileage of the players.

20. The system of claim 20, wherein the game information comprises at least one of player information constituting a team, lineup information, training information, league information, and match information.
